(19) United States
(12) Patent Application Publication
(10) Pub. No.: US 2004/0142667 A1
(43) Pub. Date: Jul. 22, 2004

(54) Method of correcting distortion in a power amplifier

(76) Inventors: Donald Laird Lochhead, San Diego, CA (US); Michael Scott Andrews, Escondido, CA (US); Robert Alan Bramble, San Diego, CA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/347,428

(22) Filed: Jan. 21, 2003

(51) Int. Cl. H04B 1/04

(52) U.S. Cl. 455/114.3; 455/114.2

(57) ABSTRACT

The invention is a method of correcting distortion in a power amplifier in a transmitter. The method includes applying an input time varying modulated data signal to the power amplifier which outputs an amplified time varying modulated data signal which is an amplification of the input time varying modulated data signal; storing samples of the input time varying modulated data signal; storing samples of the output amplified time varying data signal; using the stored input and output time varying modulated samples to provide a processor implemented model with parameters representing a non-linear characteristic of the power amplifier without the use of any polynomials; and producing predistortion coefficients.

### BACKGROUND OF THE INVENTION

1. Field of the Invention

The present invention relates to the correction of non-linear characteristics, such as phase or gain in power amplifiers (PA) for use in transmitters, such as mobile telephones or base stations.

2. Description of the Prior Art

Power amplifiers are a critical component of most digital communications systems. Higher transmission powers provide better user service and hence increased revenue. But high transmission power comes at the expense of costly devices which must accommodate the conflicting requirements of high linearity (driven by complex band limited waveforms) and higher power efficiency. Non-linear power amplifiers have high efficiency, hence much lower cost, but they cause severe signal degradation for operation near or into compression. There is a strong, economically driven need for techniques that can reduce the signal degradation of non-linear PAs.

Pre-distortion systems alter the signal entering the PA in such a way that when the signal emerges from the PA, it is close to the desired undistorted form. Existing pre-distortion techniques suffer from poor correction of complex, digital, bandwidth-conserving waveforms, which are amplified by devices operating into compression. Linearization of RF PAs results in reduced signal distortion and reduced spectral growth of the RF output. Predistortion is carefully chosen to be the inverse of the PA distortion such that the signal at the output of the PA is undistorted.

The distortion of a PA is a function of the devices therein, their nonlinear behavior, their temperature and load mismatch. In order to linearize a PA, it is necessary to estimate the nonlinearity accurately. This estimation must be updated periodically. To linearize the PA, it is necessary to use nonlinearity estimation data in a linearization algorithm. The linearization algorithm must have relative low computational requirements and be computationally stable without compromising accuracy.

FIG. 1 is a block diagram of a prior art predistortion technique described in U.S. Pat. No. 6,236,837 B1 which utilizes polynomials to estimate the PA predistortion. The technique is used for providing predistortion for linearization in a radio frequency RF PA. The technique is implemented in the following configuration: A) a polynomial predistortion unit 2 which is coupled to receive an input baseband signal and updates polynomial coefficients, for predistorting the baseband signal to provide a predistorted baseband signal in accordance with the updated polynomial coefficients, B) an RF modulator 3, coupled to the polynomial predistortion unit 2 and to an RF generator 13, which modulates the predistorted baseband signal to provide an RF signal; C) an RF PA 5, coupled to the RF modulator 3 and to a power supply 6, which amplifies the RF signal to provide an amplified RF signal; D) an RF demodulator 8, coupled to receive the amplified RF signal, which demodulates the amplified RF signal to provide a demodulated baseband signal; and E) a polynomial coefficient estimator 10, coupled to receive the predistorted baseband signal and the demodulated baseband signal, which estimates the polynomial coefficients to provide updated polynomial coefficients for the polynomial predistortion unit 2 for substantially linearizing the amplified RF signal. Voltage of the power supply 6 may be selected to be a function of the baseband signal. The polynomial coefficient estimator 10 may use orthogonal polynomial basis functions. Where selected, the device may further include an envelope generator 14, coupled to receive an input baseband signal, which computes an envelope of the input baseband signal and provides the envelope of the input baseband signal to the polynomial predistortion unit 2.

The polynomial coefficient estimator 10 can be mathematically unstable.

“Turlington” functions, described in the textbook, “Behavioral Modeling of Nonlinear RF and Microwave Devices”, by Thomas R. Turlington, Artech House, Boston 1999 (which is incorporated herein by reference in its entirety), are used for a curve fitting procedure, to model device behavior. The process described in the aforementioned textbook is described as a manual process insomuch as the process so described requires the user of the curve fitting approach to perform a visual inspection of the data, as graphed with an electronic or otherwise data charting/plotting facility, and manually derive and describe a set of asymptotic lines that fit the data, in an appropriate manner particular to the curve fitting technique described therein.

There is a need for more robust, precise, and mathematically stable algorithms that model non-linear characteristics of PAs which operate deeply into compression but are also efficient to store and compute in digital form.

### SUMMARY OF THE INVENTION

The present invention is a method of reducing distortion in a power amplifier including in a mobile RF device or a basestation which, for example, use digital modulation techniques requiring highly linear operation. The invention develops predistortion coefficients by processor implemented modeling with parameters representing a non-linear characteristic of the power amplifier without the use of polynomials. The non-linear characteristic is used to produce predistortion coefficients which are applied to a data signal which is input to the power amplifier and is amplified by the power amplifier to correct the non-linear operation of the power amplifier. The non-linear characteristic may be expressed by an equation of a form y=m×+b+c, wherein y is the output signal of the power amplifier, x is the input signal, m is a constant; and c is a non-linear function of x including logarithms. The equations may be obtained from the Turlington publication discussed above. The logarithms include a number base raised to a first power of x and additional terms. The number base may be 2 or 10. The non-linear characteristic may be at least one of gain or a phase characteristic of the power amplifier.

A method of correcting distortion in a power amplifier in a transmitter in accordance with the invention includes (a) applying an input time varying modulated data signal to the power amplifier which outputs an amplified time varying modulated data signal which is an amplification of the input time varying modulated data signal; (b) storing samples of the input time varying modulated data signal; (c) storing samples of the output amplified time varying data signal; (d) using the stored input and output time varying modulated samples to provide a processor implemented model with parameters representing a non-linear characteristic of the power amplifier without the use of any polynomials; and (e) in response to the non-linear characteristic producing predistortion coefficients which are applied to a data signal which is input to the power amplifier and amplified by the power amplifier to correct distortion in an amplification of the data signal which is an output of the power amplifier. The nonlinear characteristic may be expressed by an equation of a form y=m×+b+c wherein y is the output signal of the power amplifier, x is the input signal, m is a constant, and c is a non-linear function of x including logarithms. The logarithms may include a number base raised to a first power of x and additional terms which number base may be 2 or 10. The non-linear characteristic may be a gain and a phase characteristic, a voltage or a current gain, a temperature characteristic, or a frequency characteristic of the power amplifier.

In a mobile RF device including a power amplifier, a method of correcting distortion in the power amplifier in accordance with the invention includes (a) applying an input time varying modulated data signal to the power amplifier which outputs an amplified time varying modulated data signal which is an amplification of the input time varying modulated data signal; (b) storing samples of the input time varying modulated data signal; (c) storing samples of the output amplified time varying data signal; (d) using the stored input and output time varying modulated samples to provide a processor implemented model with parameters representing a non-linear characteristic of the power amplifier without the use of any polynomials; and (e) in response to the non-linear characteristic producing predistortion coefficients which are applied to a data signal which is input to the power amplifier and amplified by the power amplifier to correct distortion in an amplification of the data signal which is an output of the power amplifier. The nonlinear characteristic may be expressed by an equation of a form y=m×+b+c wherein y is the output signal of the power amplifier, x is the input signal, m is a constant, and c is a non-linear function of x including logarithms. The logarithms may include a number base raised to a first power of x and additional terms which number base may be 2 or 10. The non-linear characteristic may be a gain and a phase characteristic, a voltage or a current gain, a temperature characteristic, or a frequency characteristic of the power amplifier.

In a base station including a power amplifier, a method of correcting distortion in the power amplifier in accordance with the invention includes (a) applying an input time varying modulated data signal to the power amplifier which outputs an amplified time varying modulated data signal which is an amplification of the input time varying modulated data signal; (b) storing samples of the input time varying modulated data signal, (c) storing samples of the output amplified time varying data signal; (d) using the stored input and output time varying modulated samples to provide a processor implemented model with parameters representing a non-linear characteristic of the power amplifier without the use of any polynomials; and (e) in response to the non-linear characteristic producing predistortion coefficients which are applied to a data signal which is input to the power amplifier and amplified by the power amplifier to correct distortion in an amplification of the data signal which is an output of the power amplifier. The nonlinear characteristic may be expressed by an equation of a form y=m×+b+c wherein y is the output signal of the power amplifier, x is the input signal, m is a constant, and c is a non-linear function of x including logarithms. The logarithms may include a number base raised to a first power of x and additional terms which number base may be 2 or 10. The non-linear characteristic may be a gain and a phase characteristic, a voltage or a current gain, a temperature characteristic, or a frequency characteristic of the power amplifier.

### BRIEF DESCRIPTION OF THE DRAWINGS

FIG. 1 is a diagram of a prior art technique used to correct PA distortion which estimates the PA distortion using polynomials.

FIGS. 2 and 3 are simplified block diagrams of correction of PA distortion using predistortion coefficients developed in accordance with the invention.

FIG. 4 is a flow chart of PA phase and amplitude correction in accordance with the invention.

FIG. 5 is a block diagram of a mobile device or basestation which includes a PA having distortion corrected in accordance with the invention.

FIG. 6 illustrates an embodiment of the ramp module of FIG. 5.

FIG. 7 illustrates an embodiment of the 4 quad multiplier of FIG. 5.

FIG. 8 illustrates a group of the addresses which may be used to address the LUTs of FIG. 5.

FIG. 9 illustrates an embodiment of the digital upconverter of FIG. 5.

FIG. 10 illustrates an example of curve fitting to data samples of the PA amplifier response in accordance with the invention.

FIG. 11 illustrates a table containing predistortion coefficients which may be used in accordance with the invention.

FIG. 12 illustrates the functions performed in computing predistortion coefficients.

FIG. 13 illustrates a flow chart of a process performed by the analyzer of FIG. 12.

FIG. 14 illustrates a residual error measurement process used in coefficient update of FIG. 12.

FIG. 15 illustrates processing performed by the attenuation manager of FIG. 12.

FIG. 16 illustrates an embodiment of the I/Q down converter of FIG. 5.

FIGS. 17 and 18 illustrate flow charts of processes developing predistortion coefficients to correct phase and amplitude distortion in accordance with the invention.

### DESCRIPTION OF THE PREFERED EMBODIMENTS

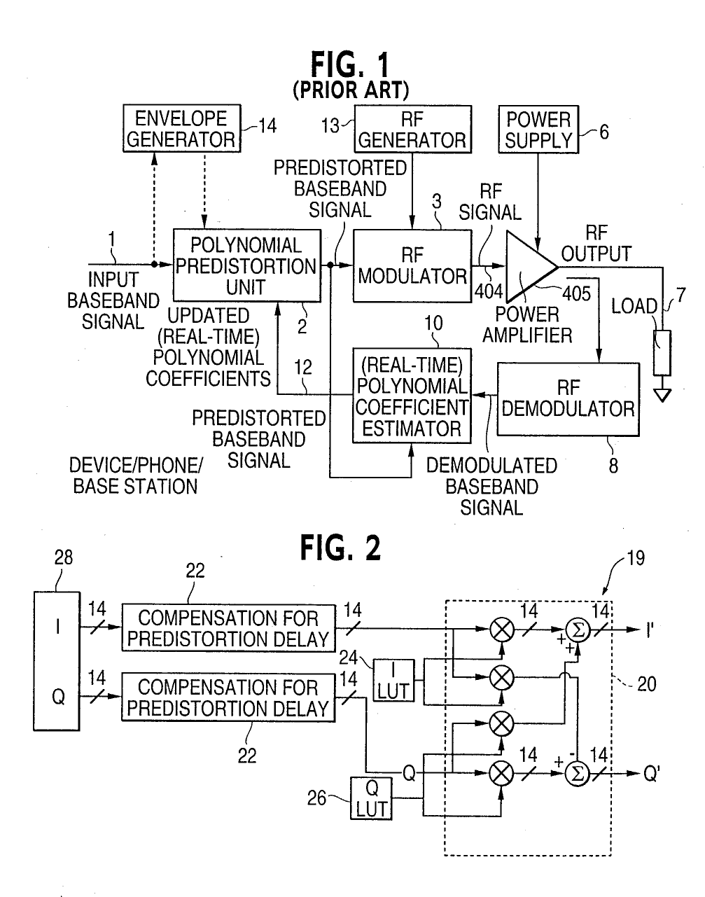

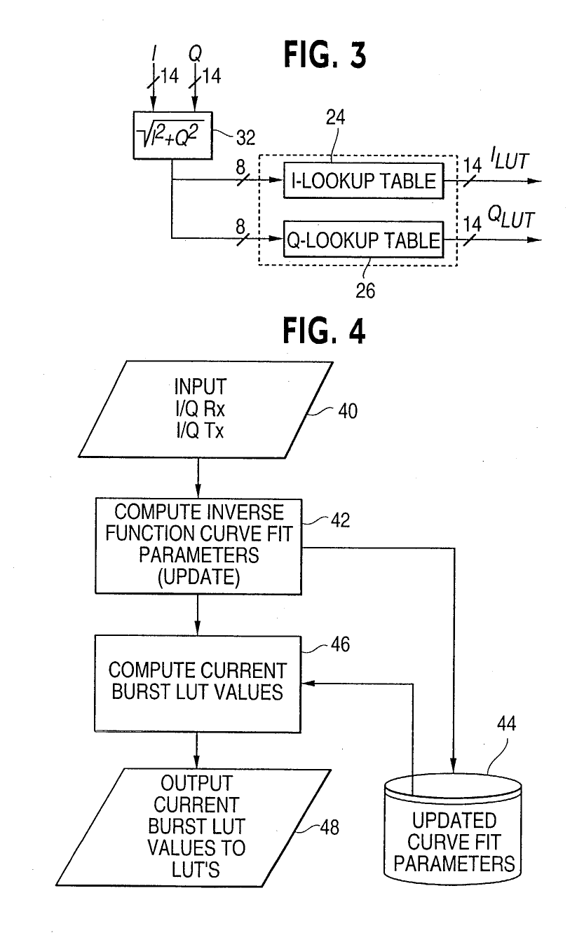

Pre-Distortion in a simplified manner in accordance with the invention is discussed with reference to FIGS. 2 and 3. The pre-distortion functions are preferably located and operate between the modulator 28 and a digital upconverter (not illustrated). A static pre-distorter 19 captures PA static non-linearities from feedback information and provides corresponding correction terms to a quadrature multiply function 20. The pre-distorter 19 quadrature (complex) multiply function 20 is preceded by delay compensation 22 for addressing I and Q LUTs 24 and 26. The quadrature multiply function 20 is a complete I and Q (4 quadrant) multiplier at the precision of the modulator 28 which may be, for example, 14 bits. The multiply function 20 takes inputs directly from the delay compensated modulator 28 and from the pre-distortion I/Q look-up tables (LUT's) 24 and 26 and outputs I′/Q′ signals, which is a static non-linearity compensated I/Q complex waveform at, for example, 14 bits precision which is subsequently input to the PA.

Burst pre-distortion coefficients are loaded into I and Q signal lookup tables 24 and 26 by a DSP (not illustrated) during blanking. The coefficients are available for an entire burst to the quadrature multiply function 20. Addressing of the LUTs 24 and 26 is achieved by calculating the I and Q modulator signal envelope as a root mean square (RMS) function 32 as illustrated in FIG. 3, from which, for example, the top 8 bits are used to derive the address of the current pre-distortion coefficient to be applied to the current I and Q signal waveform sample. The current complex pre-distortion coefficients are then read out at, for example, 14 bits precision from the I-LUT 24 and Q-LUT 26 and delivered directly to the quadrature multiply function 20. The use of a group of the most significant bits as, for example, the tops 8 bits, permits addressing of 256 locations each for I and Q signal corrections. This is adequate to cover a full 17 dB excursion range of the modulator 28.

As soon as the frequency and power step information for the current burst is known, the DSP (not illustrated) calculates the static pre-distortion coefficients directly from a stored parameter model. The coefficients are then loaded into the I-LUT 24 and Q-LUT 26 for use by the pre-distorter coefficient function. The 256 coefficients are computed directly from the stored parameter model accounting for a particular power setting and frequency. A detailed description of stored parameter model is set forth below.

An exemplary equation for use in modelling the PA non-linear characteristic may be expressed as follows:

$$\begin{matrix}y = 31.71 + \text{-} 0.046 x + \text{-} 0.237 log [ 1 + 10 \frac{( x - \text{-} 1.2801 )}{3.84} ] + \\ - 0.121 log [ \frac{10 \frac{( x - \text{-} 13.98 )}{0.63}}{1 + 10 \frac{( x - \text{-} 13.98 )}{2.17}} ] + \\ - 0.186 log [ 1 + 10 \frac{( x - 6.3704 )}{1.89} ] + \\ 0.0005 log [ \frac{10 \frac{( x - \text{-} 72.62 )}{2.17}}{1 + 10 \frac{( x - \text{-} 72.62 )}{2.17}} ] + \\ - 0.14 log [ 1 + 10 \frac{( x - 10.336 )}{0.5} ]\end{matrix}$$

In the equations, x represents input I and Q signal samples and y represents output amplified I and Q signals.

While the above equation uses logs of base 10, it should be noted that conversion of the equation to logs of base 2 is more computationally efficient for the processor implemented curve fitting process of the invention which uses stored samples of time varying data signals input to the PA input and amplified time varying data output signals to model with parameters a non-linear characteristic of the power amplifier without the use of polynomials.

The selection of the parameters in accordance with the invention eliminates the problem of instability in the prior art of FIG. 1 which uses polynomials.

The non-linear characteristic, which does not use polynomials, may be expressed in a general equation format as

y=m×+b+c

wherein y is the output signal of the PA, x is the input signal to the PA, m is a constant and C is a non-linear function of x including logarithms preferably of base 2 or base 10 but not limited thereto. The equations are characterized being a non-linear function of x which does not contain polynomials. The above equations may be obtained, without limitation, from the Turlington publication.

The non-linear characteristic of the PA may be any one or more than one of, without limitation, phase, gain, frequency, temperature including voltage or current gain characteristics of the PA.

During operation, for example, phase and amplitude static non-linearities may be modeled and updated through a curve fitting procedure using the above-described equations by a DSP or one or more processors. Fitted parameters are then stored into an online database representing the fit for a particular power step and frequency.

The generation of LUT values is outlined in the flowchart of FIG. 4. At starting point 40, stored samples, which are the input and output amplified time varying data samples of the PA, are applied to function 42 where the non-linear characteristics of the PA using the above equations is performed followed by computing of the inverse characteristic which is used to provide the requisite predistortion correction coefficients to cause the PA to output a substantially compensated amplified time varying data signal. The inverse parameters are passed to an updated curve fit parameters function 44 which causes periodic updates, such as between every burst, and to the computation of the current burst LUT values function 46. Finally, the computed current burst LUT values are passed to step 48 where the LUT values are outputted.

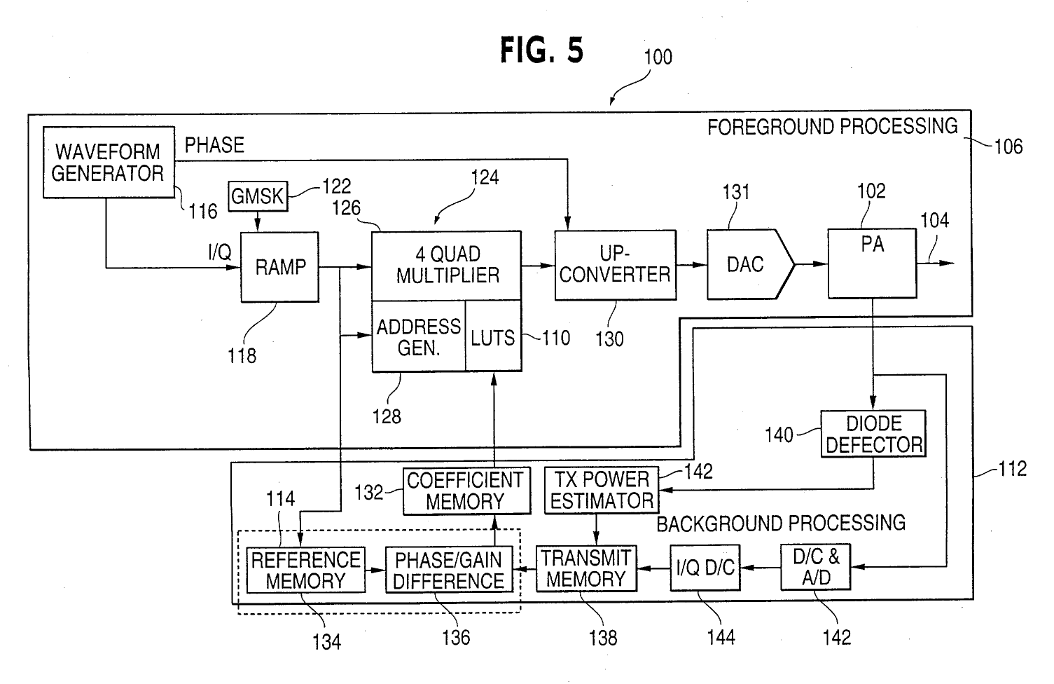

FIG. 5 illustrates a block diagram of an embodiment of the invention which is utilized without limitation in mobile devices or basestations 100 including a PA 102. Predistortion coefficients in accordance with the invention are applied to the input data signals to the PA. Preferably, the application of the predistortion coefficients is at digital baseband prior to upconverter 130 to cause the amplified time varying modulated data signal 104 to have the requisite predistortion correction for application to the PA.

The foreground process 106 of FIG. 5 controls the digital phase/gain adjustments and attenuator settings. Prior to each burst of I and Q signals, based on power step and frequency, the predistortion LUT load and an attenuator index are extracted from the coefficient memory 132. These values are then loaded during the inter-burst blanking interval and applied to the next burst.

The amount of phase and gain distortion is uniquely determined for each I and Q sample pair based on the voltage level of the pair. The equivalent voltage of each I and Q sample pair is used as an address to access the predistortion LUTs 110. The LUTs 110 store the amount of phase and gain adjustment as a predistortion correction required to compensate for the PA compression. These adjustments are applied to the I and Q sample pair. The process is then repeated for each I and Q sample pair as it is generated. A constant attenuator level is maintained over the duration of the burst.

The background process 112 periodically performs the measurements and calculations necessary to update the coefficients. If the decision is made to process a given burst as a coefficient update burst, the reference memory 114 and transmit 116 memories are configured to capture data samples from the burst. These samples are then processed by the phase/gain difference function 136 to extract the phase and gain errors. This process takes a period of time on the order of multiple bursts to complete. The decision to process a pending burst to update the coefficients is made based on how long it has been since this specific frequency/power step combination was previously updated.

The values for the predistortion coefficients are established using an iterative process that constantly adapts to changes in the transmit line-up and PA 102. This adaptation process consists of measuring the residual phase and gain errors within a burst and using the results to update the predistortion coefficients in the coefficient memory 132 to null these errors out.

The digital baseband processing is performed by the waveform generator 116, ramp module 118 and associated data modulator function 122, predistortion core 124 which is comprised of a complex multiplier 126, address generator 128 and LUTs 110, digital upconverter 130, coefficient memory 132 and residual gain and phase error smoothing function 134 which is comprised of a reference memory 114 which stores samples of the input time varying modulated data signal and phase/gain difference computation function 136. The phase/gain difference computation function 136 determines the difference between the input time varying modulated data signal samples stored in the reference memory and the samples of the amplified time varying modulated data signal output from the PA 102 which are stored in the transmit memory 138.

The amplified time varying modulated data signal, which is output from the PA 102, is detected by diode detector 140 and applied to a transmitter power estimator 142 to provide an estimation of the output power which permits the effects of amplification to be removed so that the phase/gain difference function 136 is not influenced by the power level of the output signal from the PA 102. The amplified time varying data output signal is also applied from the PA to an IF down converter and analog to digital converter 142 and then to a baseband I and Q signal down converter 144 which provides the samples of the amplified time varying data output signal which is applied to the transmit memory 138 where the effects of amplification are removed.

The waveform generator (modulator) 116 originates I and Q signals which are input to the ramp module 118 and phase signals which are input to upconverter 130. The waveform generator 116 may be implemented in programmable hardware.

Each sample pair of I and Q signals represents the instantaneous phase and amplitude of the modulated digital baseband signal. The phase signal controls the phase of the digital IF carrier used by the upconverter 130 which may, for example, be 14 MHz.

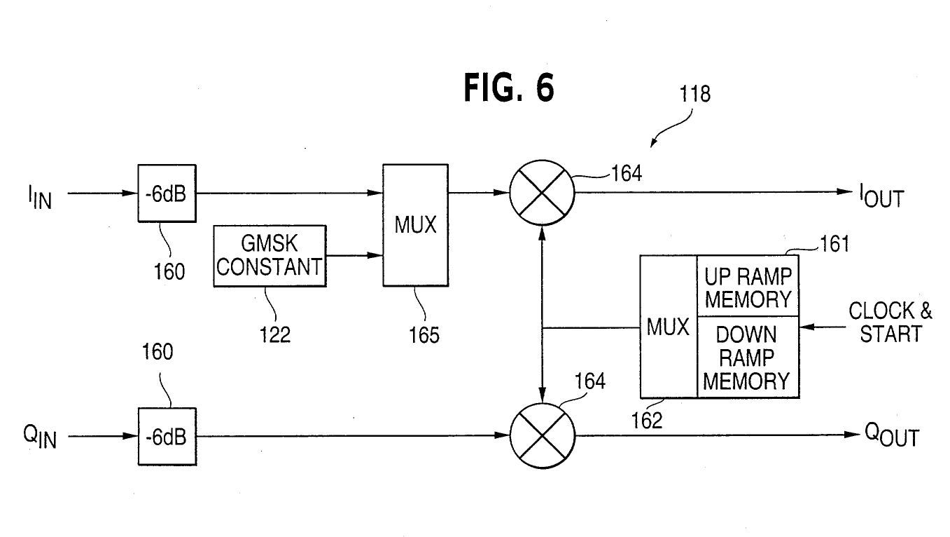

The ramp module 118 may be in accordance with FIG. 6. Elements 160 are a pair of a fixed −6 dB attenuation functions. The I and Q signal levels out of the waveform generator 116 are set to OdBFS peak. In order to create sufficient headroom to predistort the signal (apply non-linear gain expansion) and apply fine-grain gain control, this signal must be first attenuated. The second amplitude control function is provided by separate up and down ramp memories 161 (which allow for independent optimization) and multiplexer 162. The ramp coefficients are used in multipliers 164 to multiply the I and Q values by a scalar value of between 0 and 1. Each memory 161 holds values that are read out sequentially at a set rate such as, for example, 13 MHz rate (9.85 μsec ramp duration). The start time of each ramp, relative to a time slot counter (not illustrated) that counts time increments to a ramp trigger time count value, is programmable over a set range which may be from 0 to 39.2 psec with a 154 nsec resolution. The I signal is further multiplexed with a data modulator constant 122 in multiplexer 165. In the system described herein, the I signal, with a Q signal being zero, represents pure gain with no phase shift. For the application, when the data modulator uses Gaussian minimum shift keying (GMSK), the modulation envelope is constant and therefore, for modulation, there is only need to adjust gain on the I signal branch.

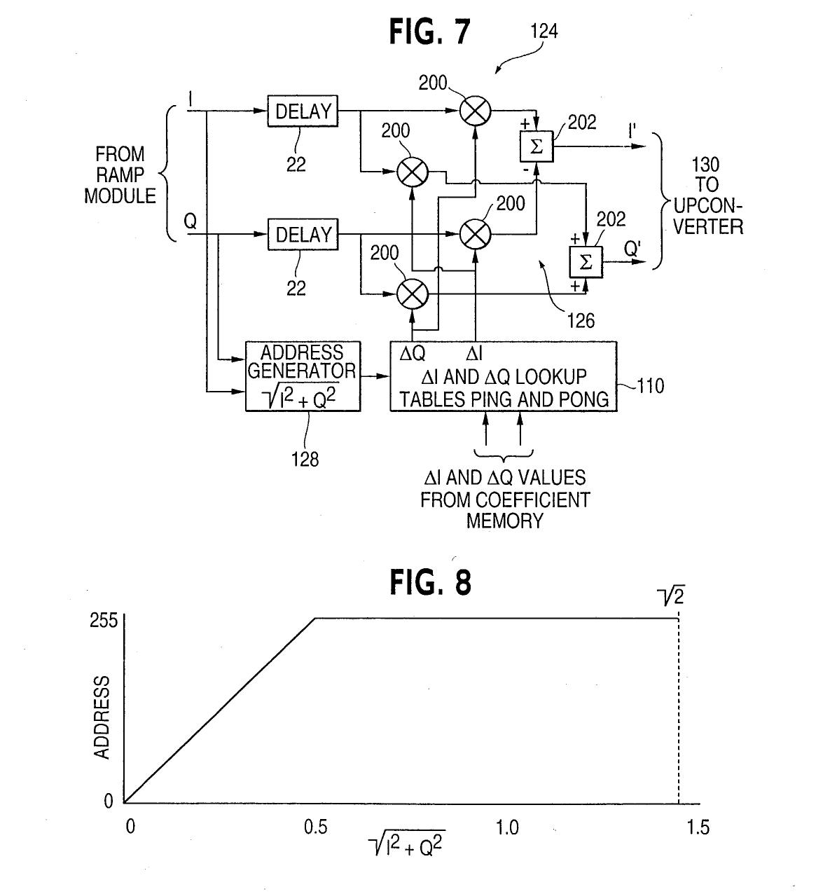

An example of the predistortion core 124 is illustrated in FIG. 7 which applies the required phase and gain predistortion to the I and Q samples using a complex multiplication. The predistortion core may be implemented in programmable hardware. The complex multiplier 126 scales the I and Q values by the ΔI and ΔQ coefficients output from the LUTs 110 on a sample-by-sample basis. The incoming samples are first delayed by delays 22 by an amount equal to the processing delay in the address generator 128 and the LUTs 110 to align the I and Q samples with the proper coefficients. The configuration of the complex multiplier 126 is known and contains a group of multipliers 200 and summers 202 which output scaled I′ and Q′ signals. The outputs from the multiplier 126 are routed to the upconverter 130.

The address generator 128 accepts the incoming I and Q samples from the waveform generator (modulator 116) and computes the index that will be used to enter the LUTs 110. The address is computed based on

Address=\sqrt{I²+Q²}

where the computation is done with a selected resolution such as 8 bits when full signal resolution is, for example, 14 bits. For simplicity, I and Q scaling coefficients can be expressed as varying from 0 to 1. In this notation, addresses vary linearly for values from 0 to 0.5, and saturate at an address of 255 for any value greater than 0.5 as illustrated in FIG. 8. This mapping reflects the fact that the maximum valid signal level at the input to the address generator 128 is −6 dBFS.

The LUTs 110 hold the ΔI and ΔQ values to be applied to the incoming I and Q samples. There are two tables: a “ping” and a “pong”. This arrangement is necessary to allow sufficient time to load the tables with the required coefficients (based on the frequency and power step) for the next burst.

Each LUT 110 holds 256 ΔI and ΔQ values that are indexed using the value computed in the address generator 128. Unique coefficients are applied to each I and Q signal pair based on the computed address thereof.

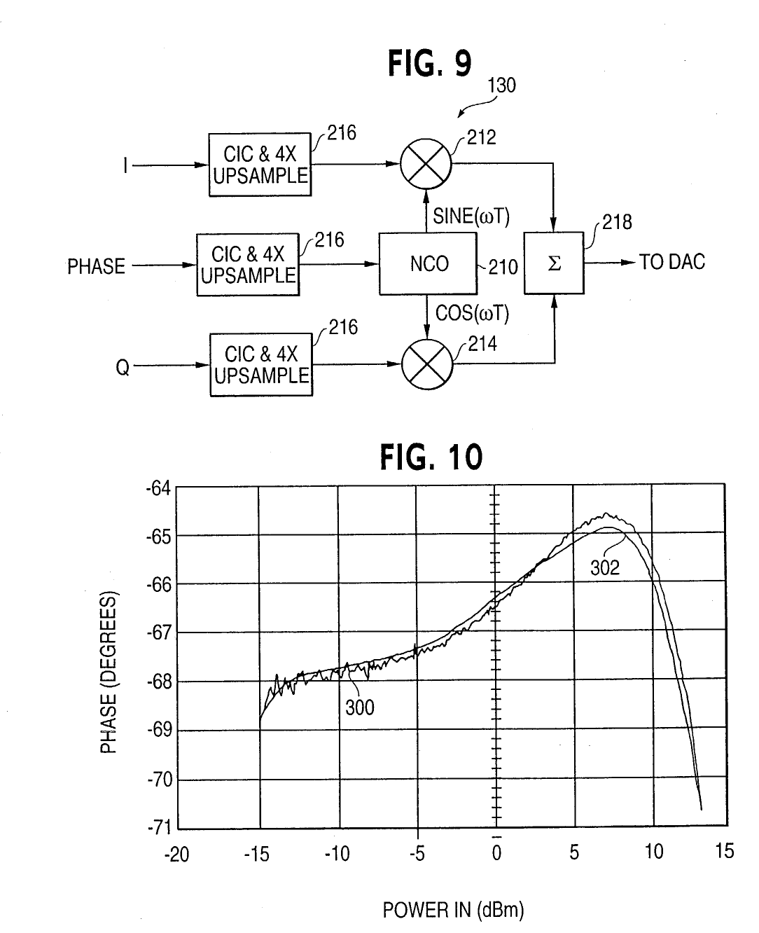

An embodiment of digital upconverter 130 is illustrated in FIG. 9. The digital upconverter 130 accepts the I and Q and phase digital baseband signals and upconverts these signals to a first IF band. The upconversion is performed using orthogonal carrier signals produced by numerical controlled oscillator 210 which are applied to mixers 212 and 214 along with the I and Q signals. The I and Q samples are first upsampled by a factor of 4 in cascade integrator and comb filters 216. The I and Q samples are then mixed with the sine and cosine signals from the NCO 210. The phase information from the waveform generator 116 may be used to directly control the phase of the signal. The intermediate frequency (IF) band I and Q signals are summed by summer 218 and output to digital to analog converter 131.

The coefficient memory 132 and residual gain a phase error smoothing function 134 performs four major functions:

A. Statistical smoothing/extrapolation of residual gain and phase errors.

B. Converting the smoothed residual of gain and phase errors from table form into coefficients for a pair of equations in I and Q signal space representing non-linear transformation curves for I and Q signals using, equations without the use of polynomials as described above and in a preferred embodiment may use a computer implemented automated process preferably with base 2 logarithms as part of the modelling of the parameters in the model.

C. Storing the I and Q curve coefficients.

D. Converting the stored coefficients back to LUT form as required based on burst power and frequency.

A. Residual Gain and Phase Error Smoothing Function 134

The residual gain and phase errors produced by the phase and gain difference function 136 are presented to the coefficient memory 132 function with “holes” where no statistics from the waveform have been collected. Furthermore, there are measurement errors present in the signals. In order to prepare the received residual gain and phase error data for curve fitting, the measurement errors must be smoothed in a statistically pleasing way. In the small signal region of the waveform statistics, the measurement errors can overwhelm the signal. The signal also fades in the small signal region so that below a certain level, there are no statistics available. The completion of the residual gain and phase errors in the small signal region is handled by use of averaging into K non-zero statistics and replacing all zero statistics with a single averaged gain and phase error value, where K represents the user-specified number of non-zero data bins to use for the averaging. In the large signal region, where the PA 102 operates in the upper-end of its dynamic range, the waveform only produces gain and phase error statistics from measurements up to a point, where the waveform reaches the maximum level in the operating dynamic range. In order represent the dynamic range of the non-linear PA 102 characteristics to the curve fitter (see below) the collected residual gain and phase errors must be extrapolated in the large signal region. This is handled by using a technique of least squares fitting of a line on the last P, where P represents the number data bins starting from the last non-zero data bin in the large signal region and including P−1 bins below, non-zero statistics in the large signal region and extrapolating from the last non-zero statistics to all remaining zero statistics until the full dynamic range of the input level is achieved. This function may be implemented in a DSP (not illustrated).

B. Curve Fitter

The conversion from residual gain and phase errors from table form into coefficients for I and Q signals may be implemented in suitable software running on the DSP. The software automates the curve fitting procedure using the equations described above which may be an automated version of the equations in the Turlington publication. The automation can be performed using any of a number of available search procedures, whereby a set of best-fit lines (in some sense) is searched to fit the data. The approach taken in the current embodiment uses “simulated annealing” to automatically find the best (in least-squares sense) set of asymptotes which fit the data. Simulated annealing is a known modeling technique belonging to a larger body of modelling techniques known as “finite element methods” and is used to provide a gain or phase characteristic (profile) of the power amplifier 102. Finite element methods use known applied mathematics techniques of linear programming, dynamic programming, constrained least squares problems and/or nonlinear least squares, etc.

The curve fitting procedure calculates coefficients for a curve representing the optimal inverse DC non-linearity that should be applied to the baseband signal to counteract non-linearities in the PA 102. A typical fitted equation (from the equations in the Turlington publication or otherwise as described above), along with a curve that is fitted for the PA 102 response is displayed in FIG. 10. The jagged line represents the samples and the smooth curve 302 represents the curve fit obtained using the automated curve fitting process.

A Coefficient Storage 132

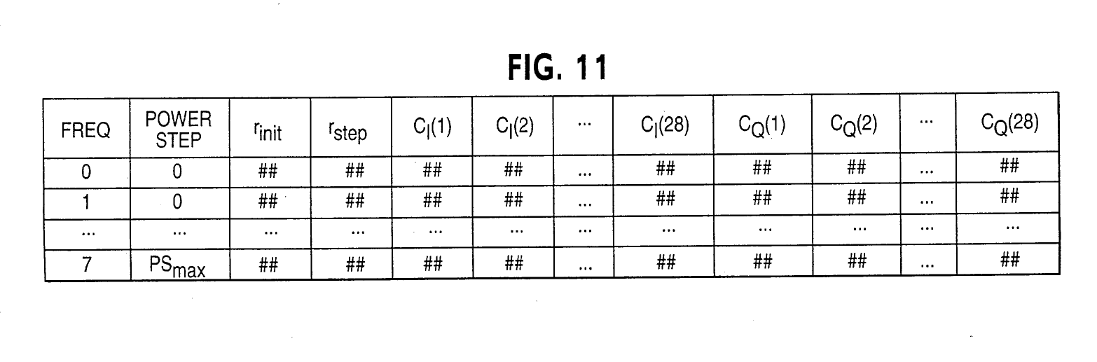

Once coefficients have been determined through the automated form of curve fitting, the coefficients are organized for hardware and stored into coefficient storage in a ASIC hardware memory 132. There are, for example, up to 46 coefficients representing curves for I and Q non-linearities (23 coefficients for I and 23 coefficients for Q). A phase control word indicates how many power steps worth of coefficients are stored and used while there may be eight fixed frequencies used to organize the coefficients. The table may be organized according to FIG. 11.

D. Transformation of Coefficients into LUT Values

During approximately each time slot clock for each I and Q signal burst, the DSP sends frequency, power step and modulation type for the next burst. Immediately upon receipt of this information, the DSP receives an interrupt at which point the DSP begins the real-time processing portion of its processing cycle. If full phase and gain correction made is enabled, the DSP looks up and loads the coefficients based on selected power step and frequency and writes the coefficients plus corresponding start increments and shifts words into hardware registers of the coefficient memory 132. The DSP then starts a real-time computing cycle using an evaluator hardware engine. The evaluator engine computes LUT values for the I and Q signal burst in parallel and stores them in the corresponding LUTs 110. This completes the action of the curve evaluator hardware.

The predistortion algorithm continuously monitors the residual phase and gain errors in the transmitted signal so that the predistortion coefficients can be updated. This algorithm extracts the required information from the actual transmitted bursts, thus avoiding the need to take unit “off-line” to inject a special measurement test signal.

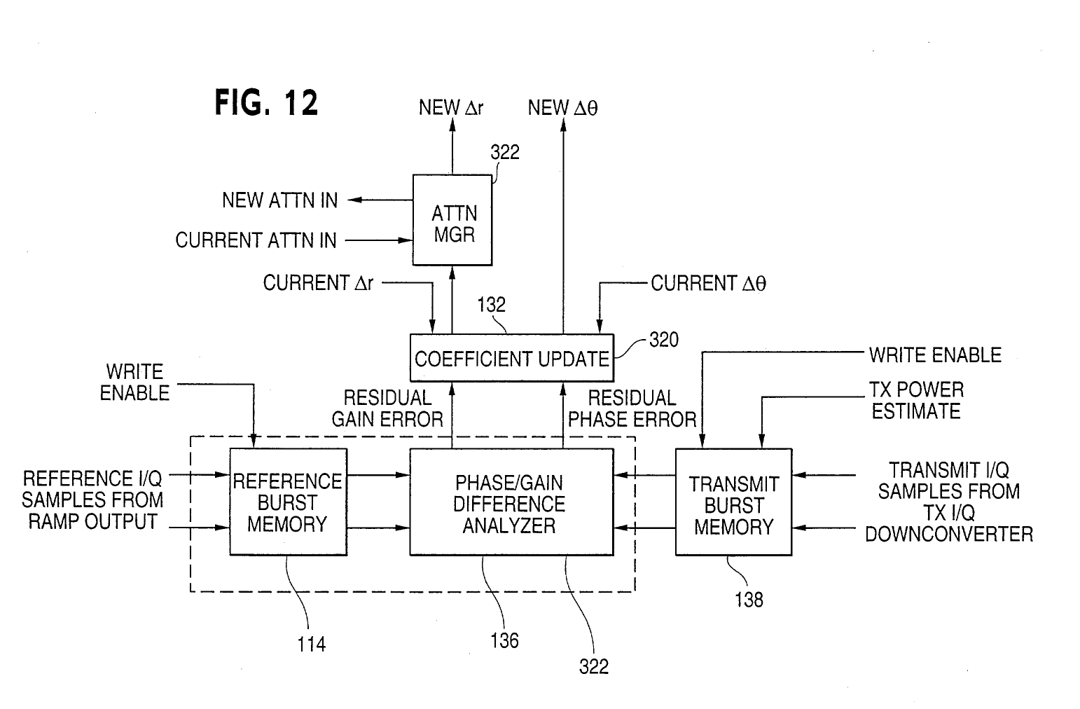

FIG. 12 illustrates the functions performed in computing predistortion coefficients. The coefficient update 320 function performed by the coefficient memory 132 stores updated phase and gain error. The reference burst memory captures 114 samples of the I and Q signal data from the output of the ramp generator 118. The data capture process may be programmed to either sample contiguous samples at a selected rate or every other sample. These two modes may be provided to allow maximum flexibility in optimizing the algorithm.

The transmit memory 138 captures the downconverted transmit I and Q signal data samples in parallel to the reference burst memory 114 with an added function. The burst mean power measurement provided by the diode detector 146 is used to calibrate the power of the data samples captured within the memory to the measured power level. This step compensates for any uncertainties within the net conversion loss within the transmit sample downconverter processing chain. A write separate enable signal, delayed relative to the reference memory write enable line by an amount calculated to compensate for the net difference in delay between the two paths, controls the memory.

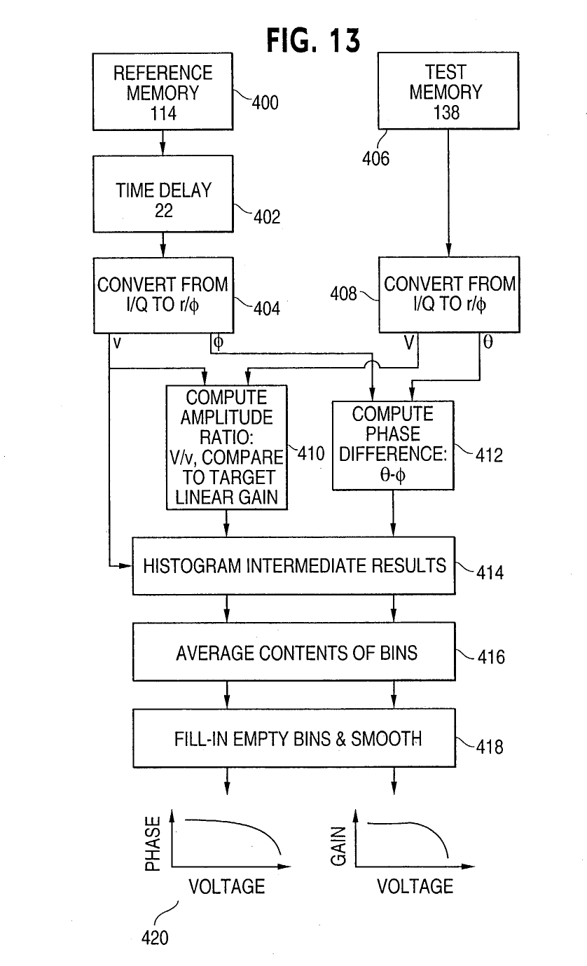

The gain and phase difference analyzer function 322 performed in the phase/gain difference function 136, after predistortion has been applied, measures residual gain and phase errors which are then used to update the predistortion coefficients of the coefficient update memory 132 to further improve the accuracy of the predistortion process. This is done with a software phase and gain difference analyzer 136 implemented as shown in the flow chart of FIG. 13.

The sequence of processing in FIG. 13 is as follows:

1. At step 400, the reference memory 114 captures burst I and Q signal samples of the transmit signal at the output of the ramp module 118. The I and Q signals are delayed at step 402 and then converted to r,φ form.

2. At step 406, test memory 138 captures a corresponding I and Q signal burst sample output from the PA 102, after downconversion and digitization. This sample, which is also originally in I and Q signal form, is also converted to r,φ form at step 408.

Three sub-processes then occur in parallel:

3. At step 410, the RMS voltage of the reference sample pair is computed based

on: ν=\sqrt{I²Q²}.

This RMS voltage is subsequently is used as an addressing index to store the compound phase and gain differences in the coefficient memory 132.

4. At step 412, the phase error of the test signal, relative to the reference signal, is computed as the difference in their respective phases.

5. Also at step 410, the gain error of the test signal, relative to the reference signal, is computed as a ratio of respective voltages, relative to the desired (linear) gain.

These intermediate results are then further processed:

6. The phase and gain errors are histogrammed at step 414 using the amplitude of the reference signal as the index.

This process is then repeated for each set of I and Q signal data samples captured in the reference memory 114 and test memory 138. After the full data set of I and Q data signals has been processed, the data is further processed to yield the final results.

7. At step 416, all of the phase and gain errors within a given histogram bin are averaged to produce a single value for the phase and gain error at the voltage level.

8. At step 418 if, due to distribution of energy in the transmitted waveform, any histogram bin is empty, the value for the bin is filled-in based on extrapolating the data from the adjacent non-empty bins.

9. At step 420, the phase and gain versus voltage data are then filtered to smooth the results. The resulting data is then in a form obtained if a classical swept power measurement of phase and gain was performed.

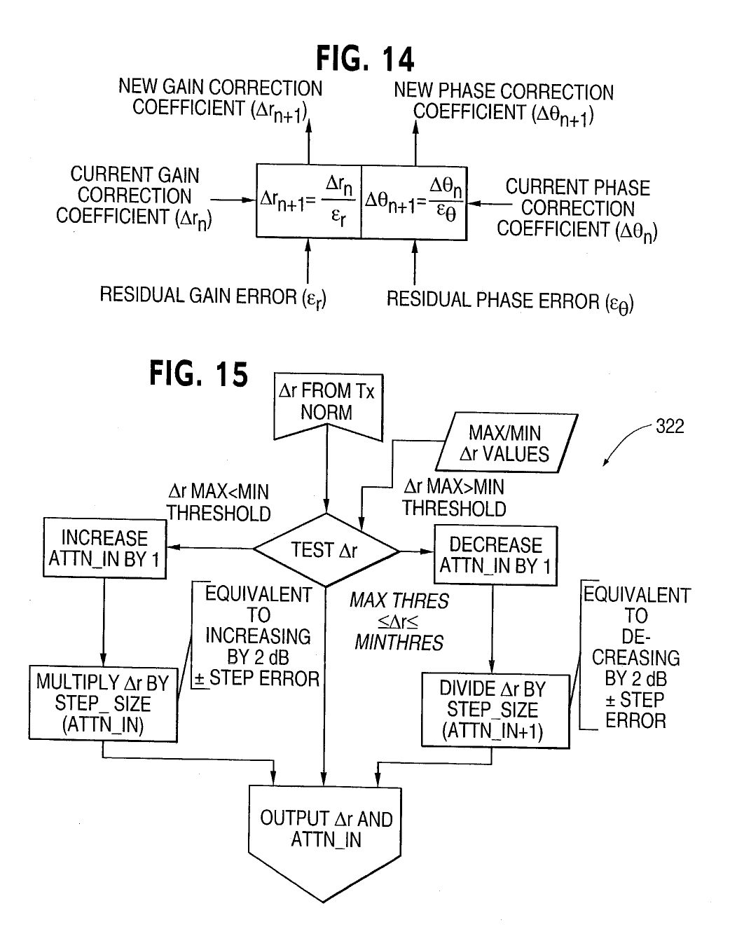

The coefficient update function in the memory 132 retrieves current values of the phase and gain predistortion coefficients and updates them using the results of the residual error measurement process as shown in FIG. 14.

The attenuation manager 322 of FIG. 12 monitors and maintains the fine grain digital data within a specific window. This optimizes the digital level into the DAC 131. If signal level into the DAC 131 drops too low, the channel signal to noise ratio (SNR) degrades. If the signal level into the DAC 131 goes too high, the digital word can reach the all 1's condition and clip the waveform.

After the updated gain correction factor is computed, the factor is tested against minimum and maximum thresholds. If the updated gain correction is within the range nothing is done. If the updated gain correction is above the threshold value, the attenuation index is decreased (increased RF channel gain) by, for example, 2 dB and an offsetting change in the digital gain control term is made. The actual change made to the digital gain control term must be compensated for the actual step value of the digital attenuators. The nominal value is 2.0 dB but, due to errors in the attenuators, the actual value can vary between 1.0 dB and 3.0 dB. If the digital gain control term is below the threshold value, the process only increments the attenuation index, which is a looked-up value by reference into a table which presents attenuation settings for a given course gain requirement which represents gain not resultant from operation of the predistortion system.

The course gain is produced by digitally controlled analog attenuators which set the proper attenuation into the PA 102 to adjust gain in accordance with the process of FIG. 15. This optimizes digital predistortion produced by the PA 102 for the limited amount of dynamic range available through digital-to-analog conversion at the output of the digital pre-distortion system. The PA 102, based upon the bias point design choice, is required to operate at a fixed gain level for every output power level that is desired. For a fixed attenuation input choice to the PA 102, the actual PA gain can vary under non-linear, linear and predistorted conditions. It is desirable to control gain on the input and output side of the PA 102. As is seen from FIG. 15, the steps of voltage gain from the transmitter Ar are tested relative to minimum and maximum thresholds Ar and accordingly increased or decreased in steps to reach the desired Ar which is output.

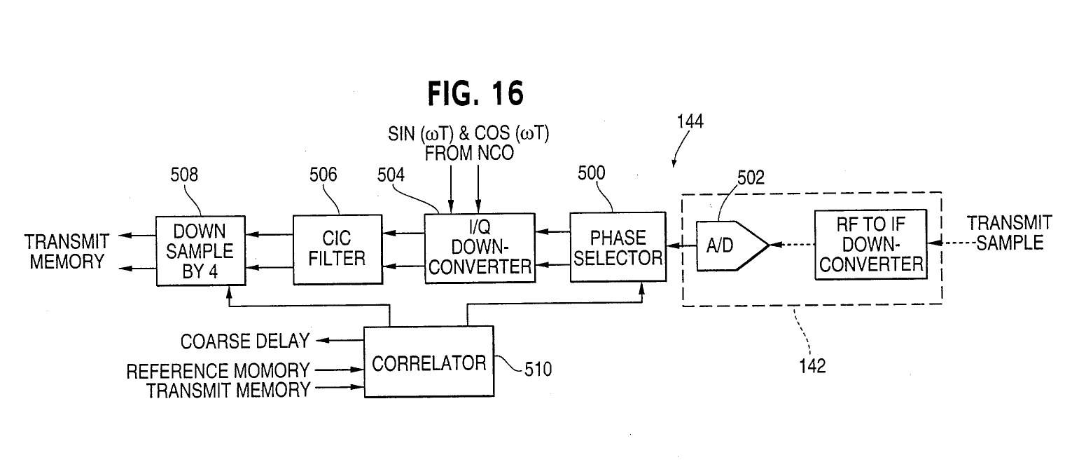

FIG. 16 illustrates an embodiment of the baseband I and Q downconverter 144. The IF to digital baseband downconverter 144 accepts the digitized output from the transmitted sample RF to the IF downconverter 142 and converts the digital IF output to digital baseband. The downconverter 144 also includes a correlation function to adaptively adjust the sampling timing between the reference memory 114 and the transmit memory 138 to compensate for the net delay through the transmit and downconversion paths.

The phase selector 500 provides for programmable selection of one of eight full phases on the sampling clock off of the analog-to-digital converter 502. The functionality is programmed by using a two bit (1-of-4) phase selection control word and an even/odd sampling control bit (for three bits total). The two bit phase selection control word causes a delay register (not illustrated) to be programmed for lengths one, two, three, and four, allowing four unique phases from the AND converter's data to enter the downconversion and downsampling parts of the I/Q downconverter chain. The even/odd sampling control bit used spits the clock and samples on one edge or the other, allowing, when combined with a programmable phase shift register, a total of 8 unique phases form the clock.

The digital downconverter 504 provided in the I/Q downconversion chain is the mirror image of the digital upconverter 130 in the digital transmit chain. In the digital downconverter 504, 1 and Q signals are mixed down to baseband from the digital IF carrier position using the same NCO hardware in the upconverter 130.

The CIC filter 506 in the downconversion chain is a low-pass filter and slows the rate of the incoming signal by a factor of four (a 4-to-1 decimator) and limits the corresponding bandwidth. The CIC filter 506 is constructed as a four-stage integrator followed by a downsampler 508.

The correlator 510 provides intelligent signal time alignment using a combination of hardware and software. The signals to be aligned are the reference and transmit waveforms captured respectively in the reference memory 114 and the transmit memory 138. The correlators 510 correlate captured signals, compute course time alignment parameters, search for fine time alignment parameters and store all time alignment related parameters into memory. A delay counter (not illustrated) for the reference memory 114 is typically fixed so that reference data is captured just after the up-ramp has completed. The delay counter (not illustrated) for the transmit memory 138 is computed based on the result of the correlations. Delay counters are used by the system to turn on data collection for the transmit and reference memories. The reference memory delay counter is typically fixed so that reference data is captured just after the up-ramp has completed. The first time through the algorithm, a correlation is performed and the count of the transport memory 138 is computed and stored. Subsequent runs through the algorithm cause the phase selector to be twiddled (modulo 2) until the correlation error becomes small relative to a one sample delay error. The algorithm finds and holds an optimized value for the phase selector.

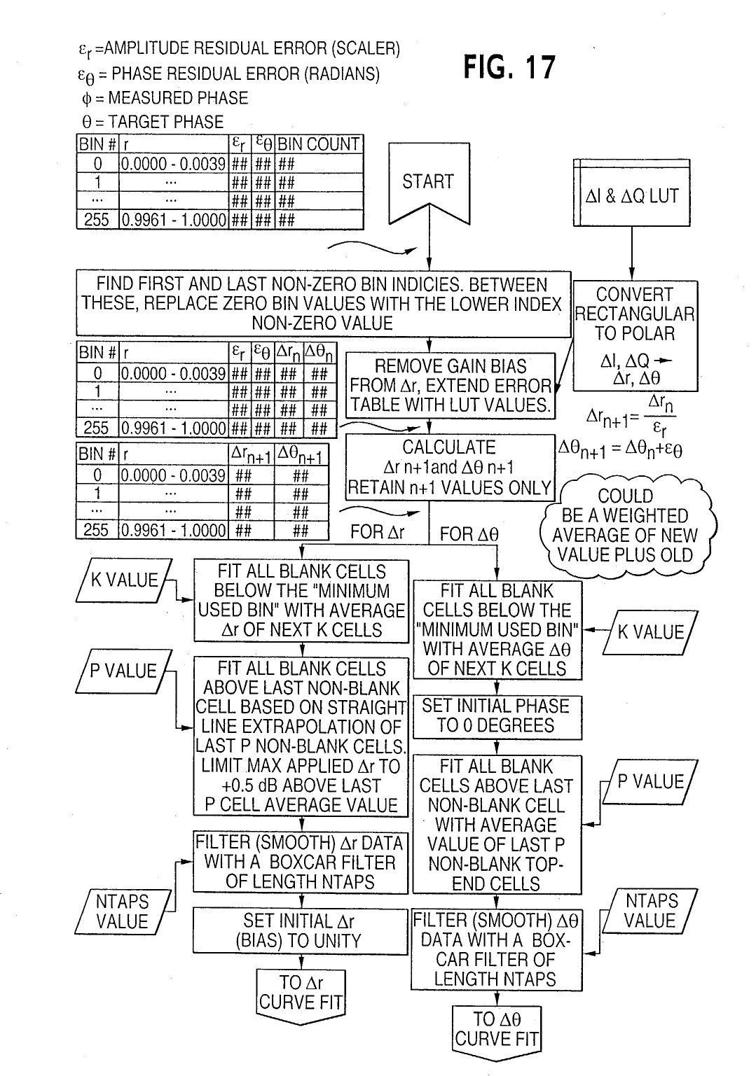

FIG. 17 illustrates a flow chart of the processing of amplitude and phase samples which are passed to the curve fitting algorithm. Amplitude and phase samples are histogrammed into bins using the reference memory amplitude value a the historgram index. Once the data is sorted into the bins, an estimation plus error of the actual non-linearity emerges.

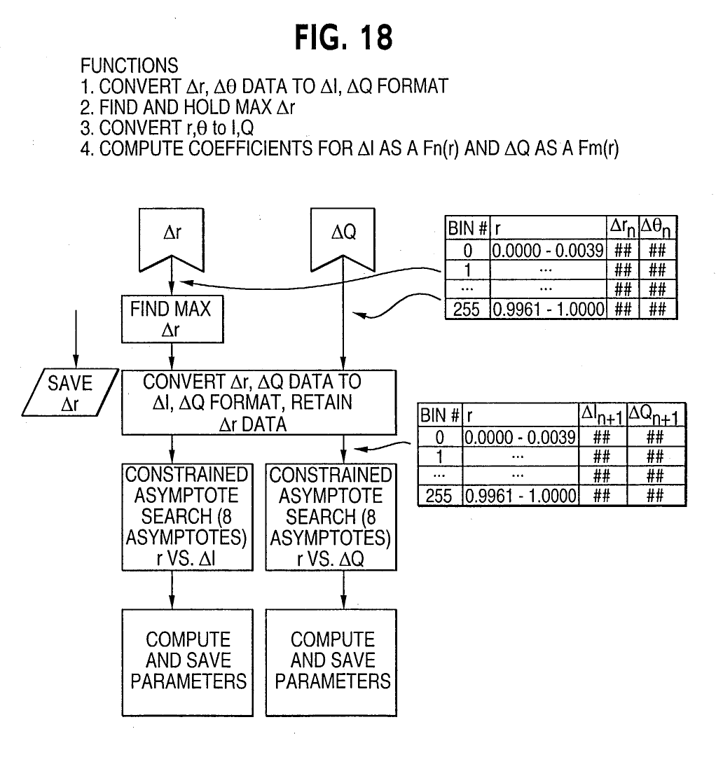

FIG. 18 illustrates the curve fitting of the amplitude and phase samples passed from the processing of FIG. 17. Amplitude and phase errors are re-incorporated in the previous non-linearity estimate and the composite result, which is a new nonlinearity estimate, is then searched for asymptotes and parameterized using a curve fitting procedure.

While the present invention has been described in terms of its preferred embodiments, it should be understood that numerous modifications may be made thereto without departing from the spirit and scope of the present invention. It is intended that all such modifications fall within the scope of the present invention.

1. A method of correcting distortion in a power amplifier in a transmitter comprising:
(a) applying an input time varying modulated data signal to the power amplifier which outputs an amplified time varying modulated data signal which is an amplification of the input time varying modulated data signal;
(b) storing samples of the input time varying modulated data signal;
(c) storing samples of the output amplified time varying data signal;
(d) using the stored input and output time varying modulated samples to provide a processor implemented model with parameters representing a non-linear characteristic of the power amplifier without the use of any polynomials; and
(e) in response to the non-linear characteristic producing predistortion coefficients which are applied to a data signal which is input to the power amplifier and amplified by the power amplifier to correct distortion in an amplification of the data signal which is an output of the power amplifier.

2. A method in accordance with claim 1 wherein:
the non-linear characteristic is expressed by an equation of a form y=m×+b+c wherein
y is the output signal of the power amplifier;
x is the input signal;
m is a constant; and
c is a non-linear function of x including logarithms.

3. A method in accordance with claim 2 wherein:
the logarithms include a number base raised to a first power of x and additional terms.

4. A method in accordance with claim 3 wherein:
the number base is 10.

5. A method in accordance with claim 3 wherein:
the number base is 2.

6. A method in accordance with claim 1 wherein:
the non-linear characteristic is a gain and a phase characteristic of the power amplifier.

7. A method in accordance with claim 6 wherein the gain characteristic comprises:
a voltage or a current gain of the power amplifier.

8. A method in accordance with claim 1 wherein:
the non-linear characteristic is a temperature characteristic of the power amplifier.

9. A method in accordance with claim 1 wherein:
the non-linear characteristic is a frequency characteristic of the power amplifier.

10. A method in accordance with claim 2 wherein:
the non-linear characteristic is a gain and a phase characteristic of the power amplifier.

11. A method in accordance with claim 2 wherein the gain characteristic comprises:
a voltage or a current gain of the power amplifier.

12. A method in accordance with claim 2 wherein:
the non-linear characteristic is a temperature characteristic of the power amplifier.

13. A method in accordance with claim 2 wherein:
the non-linear characteristic is a frequency characteristic of the power amplifier.

14. A method in accordance with claim 3 wherein:
the non-linear characteristic is a gain and a phase characteristic of the power amplifier.

15. A method in accordance with claim 3 wherein the gain characteristic comprises:
a voltage or a current gain.

16. A method in accordance with claim 3 wherein:
the non-linear characteristic is a temperature characteristic of the power amplifier.

17. A method in accordance with claim 3 wherein:
the non-linear characteristic is a frequency characteristic of the power amplifier.

18. A method in accordance with claim 4 wherein:
the non-linear characteristic is a gain and a phase characteristic of the power amplifier.

19. A method in accordance with claim 4 wherein the gain characteristic comprises:
a voltage or a current gain.

20. A method in accordance with claim 4 wherein:
the non-linear characteristic is a temperature characteristic of the power amplifier.

21. A method in accordance with claim 4 wherein:
the non-linear characteristic is a frequency characteristic of the power amplifier.

22. A method in accordance with claim 5 wherein:
the non-linear characteristic is a gain and a phase characteristic of the power amplifier.

23. A method in accordance with claim 5 wherein the gain characteristic comprises:
a voltage or a current gain.

24. A method in accordance with claim 5 wherein:
the non-linear characteristic is a temperature characteristic of the power amplifier.

25. A method in accordance with claim 5 wherein:
the non-linear characteristic is a frequency characteristic of the power amplifier.

26. In a mobile RF device including a power amplifier, a method of correcting distortion in the power amplifier comprising:
(a) applying an input time varying modulated data signal to the power amplifier which outputs an amplified time varying modulated data signal which is an amplification of the input time varying modulated data signal;
(b) storing samples of the input time varying modulated data signal;
(c) storing samples of the output amplified time varying data signal;
(d) using the stored input and output time varying modulated samples to provide a processor implemented model with parameters representing a non-linear characteristic of the power amplifier without the use of any polynomials; and
(e) in response to the non-linear characteristic producing predistortion coefficients which are applied to a data signal which is input to the power amplifier and amplified by the power amplifier to correct distortion in an amplification of the data signal which is an output of the power amplifier.

27. A method in accordance with claim 26 comprising:
the non-linear characteristic is expressed by an equation of a form y=m×+b+c wherein
y is the output signal of the power amplifier;
x is the input signal;
m is a constant; and
c is a non-linear function of x including logarithms.

28. A method in accordance with claim 27 comprising:
the logarithms include a number base raised to a first power of x and additional terms.

29. A method in accordance with claim 27 comprising:
the number base is 10.

30. A method in accordance with claim 26 comprising:
the number base is 2.

31. A method in accordance with claim 26 comprising:
the non-linear characteristic is a gain and a phase characteristic of the power amplifier.

32. In a base station including a power amplifier, a method of correcting distortion in the power amplifier comprising:
(a) applying an input time varying modulated data signal to the power amplifier which outputs an amplified time varying modulated data signal which is an amplification of the input time varying modulated data signal;
(b) storing samples of the input time varying modulated data signal;
(c) storing samples of the output amplified time varying data signal;
(d) using the stored input and output time varying modulated samples to provide a processor implemented model with parameters representing a non-linear characteristic of the power amplifier without the use of any polynomials; and
(e) in response to the non-linear characteristic producing predistortion coefficients which are applied to a data signal which is input to the power amplifier and amplified by the power amplifier to correct distortion in an amplification of the data signal which is an output of the power amplifier.

33. A method in accordance with claim 32 comprising:
the non-linear characteristic is expressed by an equation of a form y=m×+b+c wherein
y is the output signal of the power amplifier;
x is the input signal;
m is a constant; and
c is a non-linear function of x including logarithms.

34. A method in accordance with claim 33 comprising:
the logarithms include a number base raised to a first power of x and additional terms.

35. A method in accordance with claim 34 comprising:
the number base is 10.

36. A method in accordance with claim 34 comprising:
the number base is 2.

37. A method in accordance with claim 32 comprising:
the non-linear characteristic is a gain and a phase characteristic of the power amplifier.

38. In a mobile RF device including a power amplifier, a method of correcting distortion in a power amplifier comprising:
(a) applying an input time varying modulated data signal to the power amplifier which outputs an amplified time varying modulated data signal which is an amplification of the input time varying modulated data signal;
(b) storing samples of the input time varying modulated data signal;
(c) storing samples of the output amplified time varying data signal;
(d) using the stored input and output time varying modulated samples to provide a processor implemented model with parameters representing a non-linear characteristic of the power amplifier without the use of any polynomials; and
(f) in response to the non-linear characteristic producing predistortion coefficients which are applied to a data signal which is input to the power amplifier and amplified by the power amplifier to correct distortion in an amplification of the data signal which is an output of the power amplifier.

39. A method in accordance with claim 38 comprising:
the non-linear characteristic is expressed by an equation of a form y=m×+b+c wherein
y is the output signal of the power amplifier;
x is the input signal;
m is a constant; and
c is a non-linear function of x including logarithms.

40. A method in accordance with claim 39 comprising:
the logarithms include a number base raised to a first power of x and additional terms.

41. A method in accordance with claim 40 comprising:
the number base is 10.

42. A method in accordance with claim 40 comprising:
the number base is 2.
